(19) United States
(12) Patent Application Publication
(10) Pub. No.: US 2005/0086391 A1
(43) Pub. Date: Apr. 21, 2005

(54) Location sensitive software download

(75) Inventors: Simon Chu, Chapel Hill, NC (US); Richard Alan Dayan, Raleigh, NC (US); Jeffery Bart Jennings, Raleigh, NC (US); David B. Rhoades, Raleigh, NC (US)

Correspondence Address: DILLON & YUDELL LLP, 8911 N. CAPITAL OF TEXAS HWY.,, SUITE 2110, AUSTIN, TX, 78759, US

(73) Assignee: International Business machines Corporation, Armonk, NY (US)

(21) Appl. No.: 10/674,841

(22) Filed: Sep. 30, 2003

(51) Int. Cl. G06F 3/00

(52) U.S. Cl. 710/1

(57) ABSTRACT

A method and system for managing a download of software from an application server to a client computer depending on a physical location of the client computer. The client computer transmits a real-time Global Position System (GPS) coordinate to the application server. This location is then compared to a list of authorized location ranges associated with the requested application. If the client computer is located within an authorized location range, the application server then downloads the application to the client computer. If the client computer is not within an authorized area, then the application is not allowed be downloaded.

### BACKGROUND OF THE INVENTION

1. Technical Field

The present invention relates in general to the field of computers, and in particular to client computers on a network. Still more particularly, the present invention relates to a method and system for restricting a download of software from a server to a client computer based on a real-time physical location of the client computer.

2. Description of the Related Art

There are two principal methods used to load software into a computer. The first requires the user to purchase the software that is on a transportable medium such as a compact disk read only memory (CD-ROM) or floppy disk. The CD-ROM or floppy disk is inserted into the appropriate drive of the computer, which loads the software into system memory for execution, and optionally, into the computer's local hard disk drive for later use. While some such software has code that allows the software to be run for a limited number of times or for a limited period of time, typically the loaded software can be run as often and as long as the user desires.

The second method of loading software into a computer involves downloading the software over a network, such as the Internet, from an application server to a client computer on which the software will run. As with software loaded from a CD-ROM or floppy disk, the software may have an unlimited use and lifetime, or may be limited by code in the software according to the terms of the purchase agreement. The software may be downloadable to a storage medium such as a writeable CD-ROM, digital video disk (DVD), floppy magnetic disk, hard drive, etc. Alternatively, the software may be downloadable only to the client computer's system memory, thus giving the application server additional control over where, when and how the software is used and by whom.

In either method, the capability of the software may depend on updates, patches or additional licensing fees mandated by an application vendor.

With an external network, such as the Internet, a client computer may be anywhere in the world. This situation makes security issues regarding the software that may be run a complex issue. For example, current United States laws prohibit the exportation of 128-bit bulk encryption programs, but not 56-bit bulk encryption programs. This prohibition applies not only to software on CD-ROM's and other loadable media, but also to that which is downloaded from an application server. The problem for the software supplier, then, is knowing when a download is authorized to a particular client, who may be in a foreign country whose security interests are adverse to those of the United States, and thus making the download an illegal exportation.

Similarly, there are certain areas within a domestic facility where the owner of the facility restricts software use. For example, certain enterprises may have a policy that certain proprietary software is allowed to download and run only in certain areas of the enterprise campus, such as within a research laboratory, in order to protect the intellectual property of the enterprise.

Therefore, there is a need for a method and system that permits software to be downloaded from an application server for execution on a client computer only if the client computer is in an authorized physical location, whether that area be a particular country, state, city or building/room.

### SUMMARY OF THE INVENTION

The present invention is thus directed to a method and system for managing a download of software from an application server to a client computer depending on a physical location of the client computer. The client computer transmits a real-time Global Position System (GPS) coordinate to the application server. This location is then compared to a list of authorized location ranges associated with the requested application. If the client computer is located within an authorized location range, the application server then downloads the application to the client computer. If the client computer is not within an authorized area, then the software is not allowed to be downloaded.

The above, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of a preferred network system, including a client computer and an application server, used with the present invention;

FIG. 2 illustrates additional details of the content of software in the application server shown in the preferred computer system of FIG. 1;

FIG. 3 is a flow-chart of steps taken in accordance with the present invention to manage downloading software according to physical location parameters of the client computer; and

FIG. 4 is a diagram of a room in an enterprise that has a local transmitter, confined to one area, that broadcasts a location signal code to the client computer identifying where the computer is located.

### DETAILED DESCRIPTION OF THE PREFERRED EMBODIMENT

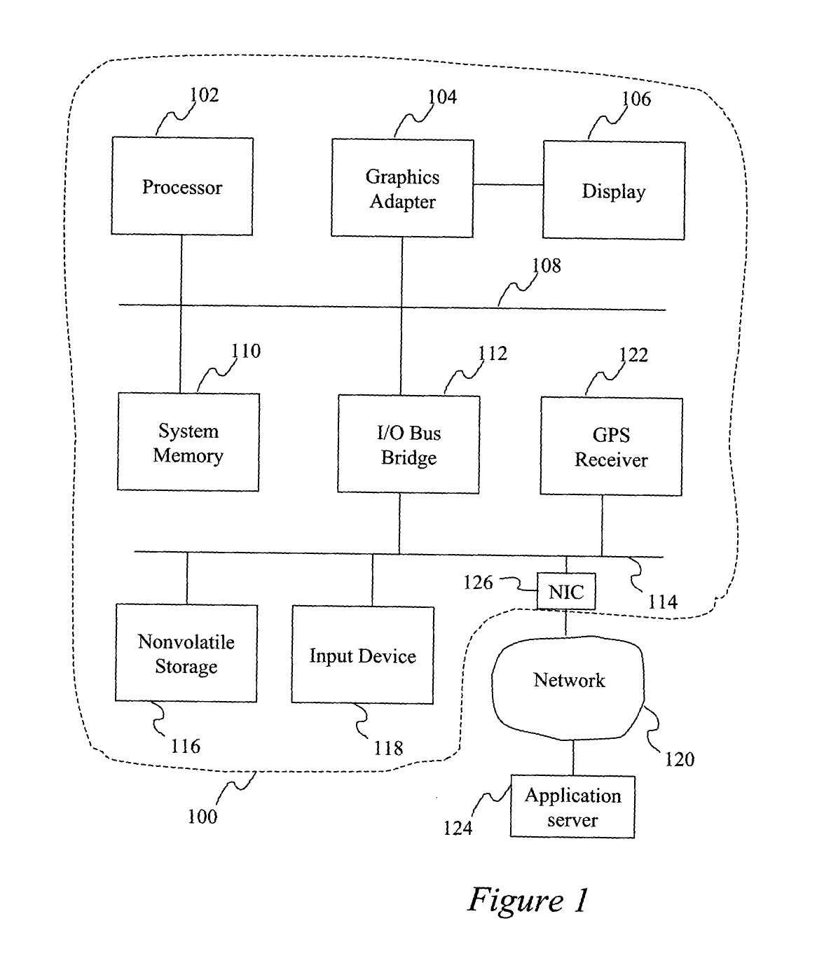

With reference now to the figures and, in particular, to FIG. 1, there is depicted a block diagram of a network 120 in which a preferred embodiment of the present invention may be implemented. Network 120 connects clients, such as a client computer 100, with an application server 124. Client computer 100 may be, for example, one of the models of computers available from International Business Machines Corporation of Armonk, N.Y. Client computer 100 may be a desktop, a laptop or a similar computer having a full-sized computer display 106, or is a device having a small computer display 106, such as a Personal Digital Assistant (PDA), a handheld computer, a tablet computing device, a wearable computer or an Internet appliance. Client computer 100 includes a processor 102, which is connected to a system bus 108. In the exemplary embodiment, data processing system 100 includes a graphics adapter 104 also connected to system bus 108, receiving information for display 106.

Also connected to system bus 108 are system memory 110 and input/output (I/O) bus bridge 112. I/O bus bridge 112 couples I/O bus 114 to system bus 108, relaying and/or transforming data transactions from one bus to the other. Peripheral devices such as nonvolatile storage 116, which may be a hard disk drive, floppy drive, a compact disk read-only memory (CD-ROM), a digital video disk (DVD) drive, or the like, and input device 118, which may include a conventional mouse, a trackball, or the like, is connected to I/O bus 114. Client computer 100 connects with network 120 via a network interface card (NIC) 126 as shown.

GPS (Global Positioning System) receiver 122 detects signals from the Global Positioning System, which is an array of satellites that orbit the Earth making it possible for ground receivers to pinpoint a geographic location. The location accuracy is anywhere from 100 to 10 meters for most equipment, and in a preferred embodiment is accurate to within one (1) meter. As known to those skilled in the art of GPS technology, multiple GPS satellites, owned and operated by the U.S. Department of Defense but available for general use around the world, are in orbit at 10,600 miles above the Earth. The satellites are spaced so that from any point on Earth, at least four satellites will be above the horizon. Each satellite contains a computer, an atomic clock, and a radio. With an understanding of its own orbit and the clock, each satellite continually broadcasts its position and time. GPS receiver 122 triangulates the position of computer 100, either using the computing power of processor 102 or a dedicated processor (not shown) within GPS receiver 122, by obtaining bearings from multiple satellites. The result is provided in the form of a geographic position—longitude and latitude. In a preferred embodiment, an additional satellite's signal is received to compute the altitude as well as the geographic position of computer 100.

Network 120 may be the Internet, an enterprise confined intranet, an extranet, or any other network system known to those skilled in the art of computers.

Application server 124 also includes (not shown) processing units and integral units, similar to those shown for client computer 100. Although application server 124's name implies that it serves applications, it is understood that application server 124 may serve (download) any type of software to a client computer via a network connection.

The exemplary embodiment shown in FIG. 1 is provided solely for the purposes of explaining the invention and those skilled in the art will recognize that numerous variations are possible, both in form and function. For instance, data processing system 100 might also include a sound card and audio speakers, and numerous other optional components. All such variations are believed to be within the spirit and scope of the present invention.

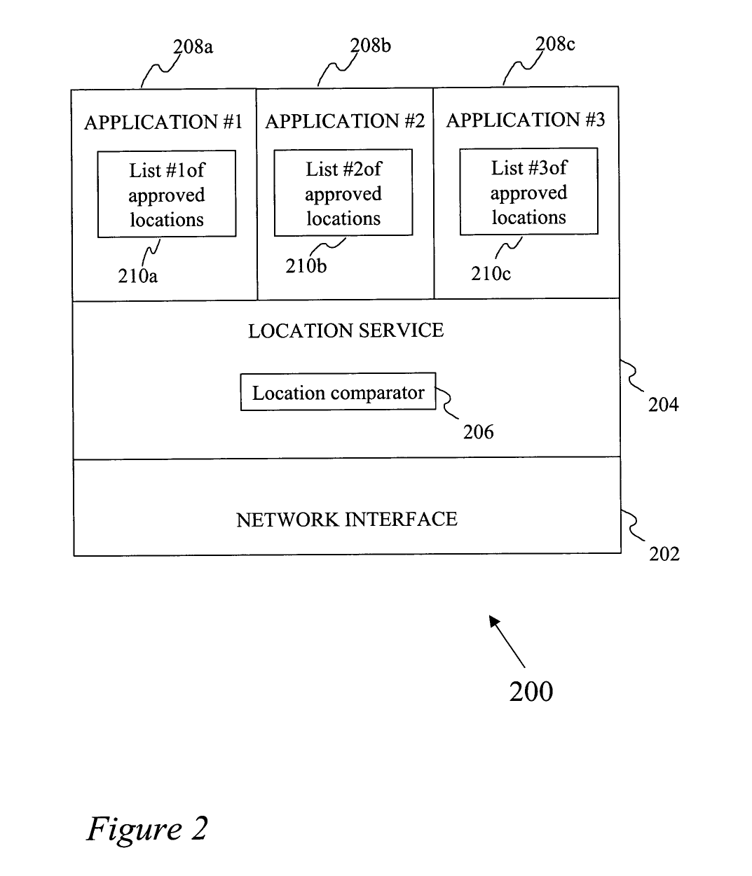

Referring now to FIG. 2, there is illustrated application server software 200 that is applicable to the present invention when executed in the application server 124 shown in FIG. 1. Application server software 200 includes a network interface software 202 for communicating with a network (shown as network 120 in FIG. 1), which permits communication with a client computer (shown as client computer 100 in FIG. 1). Application server software 200 includes a location service 204, which determines whether a particular software application is authorized to be downloaded to a client computer, as determined by the physical location of the client computer at the time of a download request. Location service 204 receives a real-time GPS coordinate from client computer 100's GPS receiver 122 (shown in FIG. 1), indicating the precise real-time physical location of client computer 100. Location service 204 then uses a location comparator 206 to compare the received client computer real-time GPS coordinate with a list of approved locations 210 that is associated with a called application 208. If the client computer's real-time GPS coordinate is within a range of locations found in a list 210, then the requested application 208 is permitted to be downloaded to the client computer over the network. If the real-time GPS coordinate is not within the range of locations found in a list 210 associated with the requested application 208, then the requested application 208 is not allowed to be downloaded to the client computer.

Multiple applications 208a-c are depicted within application server software 200. Such applications may include word processors, spreadsheets, graphics, programs, games or the like, but more significantly include security sensitive applications, such as bulk encryption programs or other programs that contain proprietary programming code or sensitive data (enterprise trade secrets or national security secrets). Each application 208 contains or is associated with a corresponding list of approved locations 210, which describe the geographical locations in which the associated application is authorized to run. Thus, list 210a contains a range of GPS coordinates in which the client computer must physically be located in order to permit application 208a to be downloaded to the client computer.

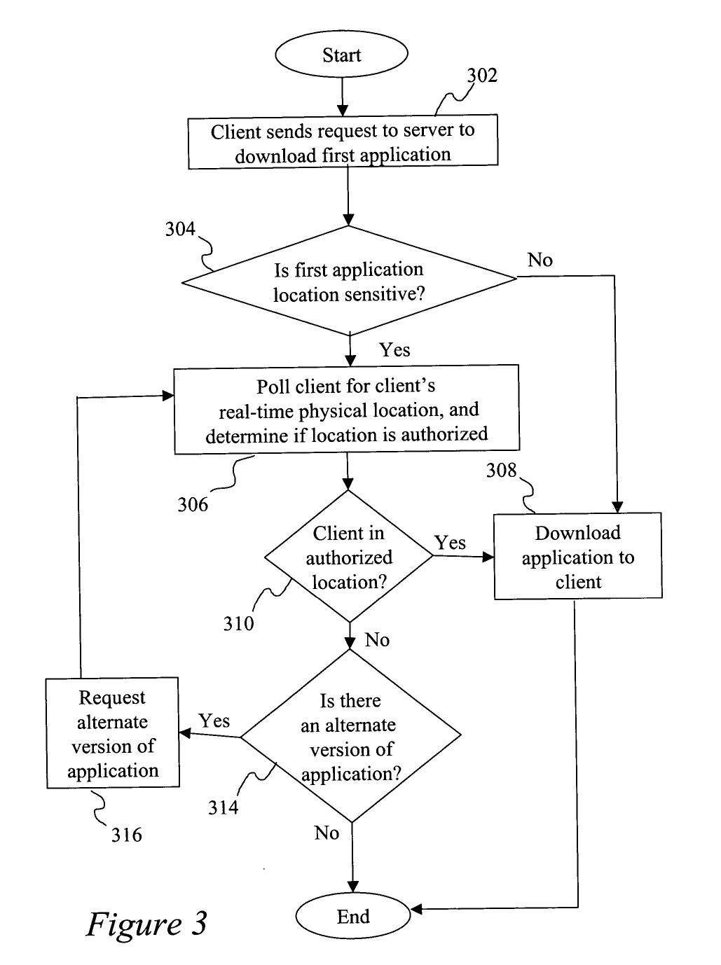

With reference now to FIG. 3, there is depicted a flow-chart of a preferred embodiment of the present invention. Starting at block 302, a client computer sends a request to the application server for a first application. A query is made (block 304) as to whether the first application requested is location sensitive. If not, then the application is allowed to be downloaded to the client computer (block 308), assuming that there are no other security feature requirements that must be met, such as password protection, retina scan inputs, etc. If the first application requested is location sensitive, then the application server polls the client computer for the client computer's real-time physical location. The client computer sends information from its GPS receiver or other location identifier to determine the current real-time location of the client computer, and returns this location to the application server. The location service in the application server then compares the GPS coordinates received from the client computer with the list of authorized locations for the first requested application to determine if the client computer is in a location where a download is authorized (block 306).

If the client computer is in a location where the first application is authorized to run (query block 310), then the first application is downloaded to the client computer from the application server (block 308).

If a determination was made at decision block 310 that the client computer was not in an authorized location to download and run the requested first application, a query (query block 314) is made as to whether an alternate version of the requested first application is available. For example, the first application may have been a 128-bit bulk encryption program, and an alternate application may be a 56-bit bulk encryption program. If such an alternate program is available, then the client computer requests that alternate program (block 316), and the application server determines if the client computer is authorized to download the alternate program from the application server based on the client computer's physical location (blocks 306 and 310). The process continues until an alternate version of the application is located that is authorized to be downloaded to the client computer's current physical location (block 308), or else the process ends without an application being loaded and run. Alternatively, the application server can sua sponte offer an alternative program that the application server has already determined is authorized for downloading to the client computer's present location.

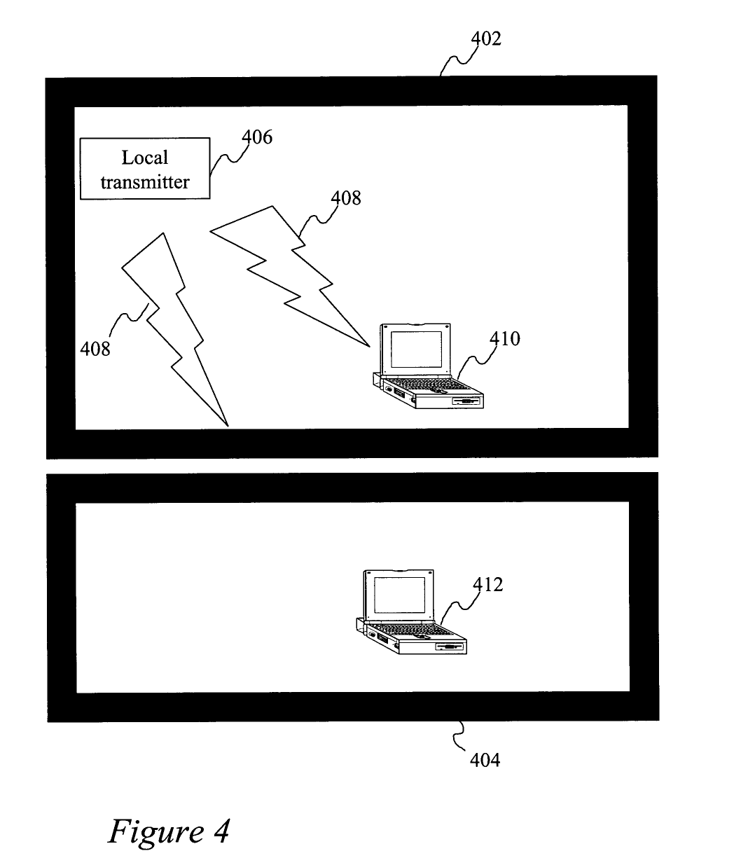

While authorized location list 210 has been describe above as relating to GPS signals, list 210 may contain alternative coordinate listings supplied to application server 124, including a coordinate supplied by an enterprise defined system. That is, an enterprise may have a coordinate location identifier supplied by a local transmission system. Referring then to FIG. 4, an enterprise may have a location identifying system uniquely identifying each location within the enterprise's campus. For example, room 402 may be the only room (such as a laboratory) in which a client computer 410 is allowed to download and run an application that is proprietary to the enterprise and/or operates on secret data revealed to and by the proprietary application. A local transmitter 406, operated by the enterprise, transmits a unique signal 408, preferably a digital signal, encrypted or not, that provides a unique identifier for room 402. Signal 408 is confined within room 402, either by the limited broadcast range of local transmitter 406, a radio frequency (RF) shield surrounding room 402, or by other means that restricts an interpretable version of signal 408 to room 402. Thus, computer 412 in room 404 is unable to receive and/or interpret signal 408. Computer 410, having a location receiver similar to GPS receiver 122, is therefore able to download only applications that are authorized to be downloaded and run in room 402. Similarly, computer 412 is unable to download an application that is authorized to only download in room 402. In an alternate embodiment, local transmitter 406 is a repeater transmitter that repeats a true GPS signal received on a land-line, assuming that the GPS signal cannot penetrate room 402. Thus, if the GPS signal provides adequate resolution, the GPS signal may be used to be compared with the GPS based list of authorized locations down to the room level.

Alternatively, location service 204 may be structured such that the presence or lack of a GPS or other location signal being detected by a client computer either enables or prohibits the loading of an application. Thus, an application may be constructed such that if the GPS receiver 122 does not detect a GPS signal, then it is presumed that the client computer 410 is in a secure location, and the application may be downloaded. In an alternative embodiment of the present invention, the application will download only with the detection of a GPS or other location signal.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

1. A method for regulating a download of a software from a server to a client computer on a network, the regulating being determined by a physical location of the client computer on which the software is to be downloaded, the method comprising:
storing a first list of authorized location ranges where a client computer is authorized to receive a download of a software from a server;
determining a physical location of the client computer;
comparing the physical location of the client computer with the first list of authorized location ranges; and
downloading the first software only if the physical location of the client computer is within the range of one of the authorized location ranges from the first list of authorized location ranges.

2. The method of claim 1, further comprising:
upon determining that the physical location of the client computer is not within the first list of authorized location ranges, requesting a download of a second software, the second software having a second list of authorized location ranges;
comparing the physical location of the client computer with the second list of authorized location ranges, and
downloading the second software only if the physical location of the client computer is within the range of one of the authorized location ranges from the second list of authorized location ranges.

3. The method of claim 1, further comprising:
upon determining that the client computer is not located within an authorized area for the requested software download, generating an alert to a software administrator server of the unauthorized area in which the client computer is located while attempting to download a restricted application.

4. The method of claim 2, wherein the first and second lists of authorized location ranges are stored in the server.

5. The method of claim 1, wherein the physical location of the computer is determined from a Global Positioning System (GPS) signal.

6. The method of claim 1, wherein the physical location of the computer is determined from a local enterprise generated signal.

7. The method of claim 6, wherein the local enterprise generated signal is confined to a single room.

8. A system for regulating a download of a software from a server to a client computer on a network, the regulating being determined by a physical location of the client computer on which the software is to be downloaded, the system comprising:
means for storing a first list of authorized location ranges where a client computer is authorized to receive a download of a software from a server;
means for determining a physical location of the client computer;
means for comparing the physical location of the client computer with the first list of authorized location ranges; and
means for downloading the first software only if the physical location of the client computer is within the range of one of the authorized location ranges from the first list of authorized location ranges.

9. The system of claim 8, further comprising:
means for, upon determining that the physical location of the client computer is not within the first list of authorized location ranges, requesting a download of a second software, the second software having a second list of authorized location ranges;
means for comparing the physical location of the client computer with the second list of authorized location ranges, and
means for downloading the second software only if the physical location of the client computer is within the range of one of the authorized location ranges from the second list of authorized location ranges.

10. The system of claim 8, further comprising:
means for, upon determining that the client computer is not located within an authorized area for the requested software download, generating an alert to a software administrator server of the unauthorized area in which the client computer is located while attempting to download a restricted application.

11. The system of claim 9, wherein the means for storing the first and second lists of authorized location ranges are in the server.

12. The system of claim 8, wherein the physical location of the computer is determined from a Global Positioning System (GPS) signal.

13. The system of claim 8, wherein the physical location of the computer is determined from a local enterprise generated signal.

14. The system of claim 13, wherein the local enterprise generated signal is confined to a single room.

15. A computer program product, residing on a computer usable medium, for regulating a download of a software from a server to a client computer on a network, the regulating being determined by a physical location of the client computer on which the software is to be downloaded, the computer program product comprising:
program code for storing a first list of authorized location ranges where a client computer is authorized to receive a download of a software from a server;
program code for determining a physical location of the client computer;
program code for comparing the physical location of the client computer with the first list of authorized location ranges; and
program code for downloading the first software only if the physical location of the client computer is within the range of one of the authorized location ranges from the first list of authorized location ranges.

16. The computer program product of claim 15, further comprising:
program code for, upon determining that the physical location of the client computer is not within the first list of authorized location ranges, requesting a download of a second software, the second software having a second list of authorized location ranges;
program code for comparing the physical location of the client computer with the second list of authorized location ranges, and
program code for downloading the second software only if the physical location of the client computer is within the range of one of the authorized location ranges from the second list of authorized location ranges.

17. The computer program product of claim 16, wherein the first and second lists of authorized location ranges are stored in the server.

18. The computer program product of claim 15, wherein the physical location of the computer is determined from a Global Positioning System (GPS) signal.
